(19) United States
(12) Patent Application Publication
(10) Pub. No.: US 2020/0147691 A1
(43) Pub. Date: May 14, 2020

(54) Ultrasonic Monitoring of Additive Manufacturing

(71) Applicant: Applied Materieals, Inc., Santa Clara, CA (US)

(72) Inventors: Ajey M. Joshi, San Jose, CA (US); Kamala Chakravarthy Raghavan, Santa Clara, CA (US)

(21) Appl. No.: 16/680,450

(22) Filed: Nov. 11, 2019

Related U.S. Application Data
(60) Provisional application No. 62/767,450, filed on Nov. 14, 2018.
(60) Provisional application No. 62/811,975, filed on Feb. 28, 2019.

(51) Int. Cl. B22F 3/105; B33Y 10/00; B33Y 30/00; B33Y 50/02

(52) U.S. Cl. CPC B22F 3/1055; B33Y 10/00; B22F 2003/1057; B33Y 50/02; B33Y 30/00

(57) ABSTRACT

An additive manufacturing apparatus includes a platform having a top surface to support a part being constructed, a dispenser configured to deliver a plurality of successive layers of feed material onto the platform, at least one energy source to selectively fuse feed material in a layer on the platform, and an in-situ monitoring system comprising a plurality of ultrasonic sensors acoustically coupled to the platform and configured to transmit ultrasonic energy through the platform to the part being constructed on the platform and receive reflections of the ultrasonic energy through the platform from the part.

### CROSS-REFERENCE TO RELATED APPLICATIONS

This application claims priority to U.S. Provisional Application Ser. No. 62/767,450, filed on Nov. 14, 2018, and to U.S. Provisional Application Ser. No. 62/811,975, filed Feb. 28, 2019, both of which are incorporated by reference.

### TECHNICAL FIELD

This disclosure relates to monitoring of additive manufacturing, also known as 3D printing.

### BACKGROUND

Additive manufacturing (AM), also known as solid freeform fabrication or 3D printing, refers to a manufacturing process where three-dimensional objects are built up from successive dispensing of raw material (e.g., powders, liquids, suspensions, or molten solids) into two-dimensional layers. In contrast, traditional machining techniques involve subtractive processes in which objects are cut out from a stock material (e.g., a block of wood, plastic, composite, or metal).

A variety of additive processes can be used in additive manufacturing. Some methods melt or soften material to produce layers, e.g., selective laser melting (SLM) or direct metal laser sintering (DMLS), selective laser sintering (SLS), or fused deposition modeling (FDM), while others cure liquid materials using different technologies, e.g., stereolithography (SLA). These processes can differ in the way layers are formed to create the finished objects and in the materials that are compatible for use in the processes.

In some forms of additive manufacturing, a powder is placed on a platform and a laser beam traces a pattern onto the powder to fuse the powder together to form a shape. Once the shape is formed, the platform is lowered and a new layer of powder is added. The process is repeated until a part is fully formed.

### SUMMARY

In one aspect, an additive manufacturing apparatus includes a platform having a top surface to support a part being constructed, a dispenser configured to deliver a plurality of successive layers of feed material onto the platform, at least one energy source to selectively fuse feed material in a layer on the platform, and an in-situ monitoring system comprising a plurality of ultrasonic sensors acoustically coupled to the platform and configured to transmit ultrasonic energy through the platform to the part being constructed on the platform and receive reflections of the ultrasonic energy through the platform from the part.

Implementations may include one or more of the following features.

A computer may have a non-transitory computer readable medium having instructions to receive signals from the in-situ monitoring system and perform ultrasonic imaging of the part being constructed based on the signals. The computer-readable medium may have instructions to compare an ultrasound image of the part to data indicating a desired shape of the part.

The plurality of ultrasonic sensors may be acoustically coupled to a bottom surface of the platform. The plurality of ultrasonic sensors may contact the bottom surface of the platform, or a layer of coupling gel may be disposed between the plurality of ultrasonic sensors and the bottom surface of the platform. The plurality of ultrasonic sensors may be fixed in position relative to the platform. The plurality of ultrasonic sensors may be movable parallel to the top surface of the platform. A support may hold the plurality of ultrasonic sensors, and a linear actuator may move the support relative to the platform.

At least some of the plurality of transducers may be oriented to transmit acoustic waves into the platform at an oblique angle to the top surface of the platform. The plurality of transducers may include multiple groups of transducers, and each transducer in a group of transducers may be oriented to transmit acoustic waves toward a point between the transducers of the group. The groups of transducers may be pairs or tuples of transducers. At least some of the plurality of transducers may be oriented to transmit acoustic waves into the platform at a normal angle to the top surface of the platform. A least some of the plurality of transducers may be positioned to receive the reflections of the ultrasonic energy from overlapping regions on the top surface of the platform.

In another aspect, a method of additive manufacturing of a part includes, for each layer of a plurality of layers, dispensing a layer of powder on a platform, selectively fusing a portion of the layer of powder to form a fused portion of the layer, transmitting ultrasonic energy through the platform toward the fused portion of the layer, and generating signals by measuring reflections of the ultrasonic energy through the platform from the fused portion. Defects are detected in the part based on the signal.

Implementations may include one or more of the following features. Ultrasonic imaging of the part being constructed may be performed based on the signals. An ultrasound image of the part may be compared to data indicating a desired shape of the part. Fabrication of the part may be halted or the part may be indicated as defective if a number or density of defects exceeds a threshold. An operating parameter of an additive manufacturing apparatus that performs the dispensing and fusing may be modified for a subsequent layer or a subsequent part to reduce defects.

Particular implementations of the subject matter described in this disclosure can be implemented so as to realize one or more of the following advantages.

The details of one or more implementations are set forth in the accompanying drawings and the description. Other features, aspects, and advantages of the subject matter will become apparent from the description, the drawings, and the claims.

### BRIEF DESCRIPTION OF THE DRAWINGS

FIG. 1 is a schematic side view of an example additive manufacturing apparatus.

FIGS. 2A and 2B are schematic side and top views of a printhead from the additive manufacturing apparatus.

FIG. 3 is a schematic cross-sectional side view of an additive manufacturing apparatus with an ultrasonic monitoring system.

FIG. 4 is a schematic cross-sectional side view of a transducer.

FIG. 5 is portion of the additive manufacturing apparatus.

Like reference numbers and designations in the various drawings indicate like elements.

### DETAILED DESCRIPTION

A part constructed by additive manufacturing can include internal defects. For example, for the powder in voxels in the interior of the part may not be completely fused, or fused voxels in the interior of the part can be formed with inclusions, pores or similar defects. Detection of internal defects in additively built parts is a challenge. Conventionally, tests for defect detection are performed after the additive manufacturing build process. In addition, most testing techniques are destructive, and thus require fabrication of sacrificial and control parts in order to obtain information regarding defects.

However, in-situ detection and monitoring of internal defects can be performed using ultrasonic monitoring, e.g., ultrasonic imaging. Data gathered by ultrasonic monitoring can be used to identify parts that do not meet manufacturing standards or dimensional specifications, to abort fabrication process of a part, to improve the additive manufacturing process for subsequent parts, and to trigger correction of the defects during the fabrication of the part. This can provide significant improvements to manufacturing cost, time and yield.

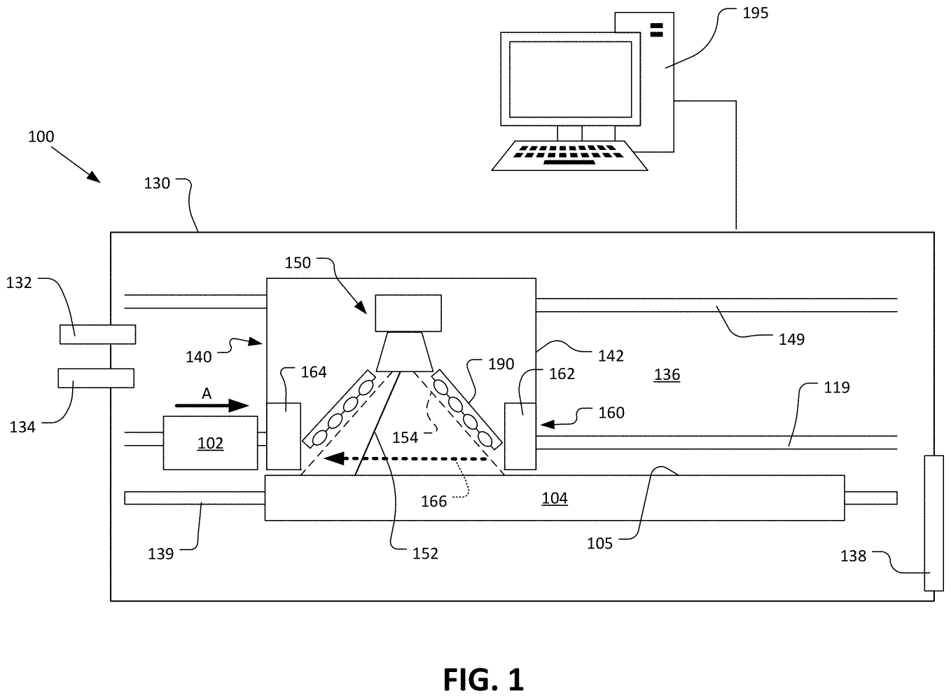

Additive Manufacturing Apparatus FIG. 1 illustrates a schematic side view of an example additive manufacturing (AM) apparatus 100 that includes a printhead 102 and a build platform 104 (e.g., a build stage). The printhead 102 dispenses layers of one or more powders on a top surface 105 of the platform 104. By repeatedly dispensing and selectively fusing the layers of powder, the apparatus 100 can form a part on the platform.

The printhead 102 and the build platform 104 can both be enclosed in a housing 130 that forms a sealed chamber 136, e.g., a vacuum chamber, that provides a controlled operating environment. The chamber 130 can include an inlet 132 coupled to a gas source and an outlet 134 coupled to an exhaust system, e.g., a pump. The gas source can provide an inert gas, e.g. Ar, or a gas that is non-reactive at the temperatures reached by the powder for melting or sintering, e.g., N₂. This permits the pressure and oxygen content of the interior of the housing 130 to be controlled. For example, oxygen gas can be maintained at a partial pressure below 0.01 atmospheres.

The chamber 136 may be maintained at atmospheric pressure (but at less than 1% oxygen) to avoid the cost and complexity of building a fully vacuum compatible system. Oxygen content can be below 50 ppm when the pressure is at 1 atmosphere, e.g., when dealing with Ti powder particles. A valve 138 can be used to separate the chamber 136 from the external environment while permitting parts, e.g., the build platform with the fabricated object, to be removed from the chamber. For example, the build platform 104 can be placed on rollers, and/or or be engageable to and movable on a track 139, e.g., a rail.

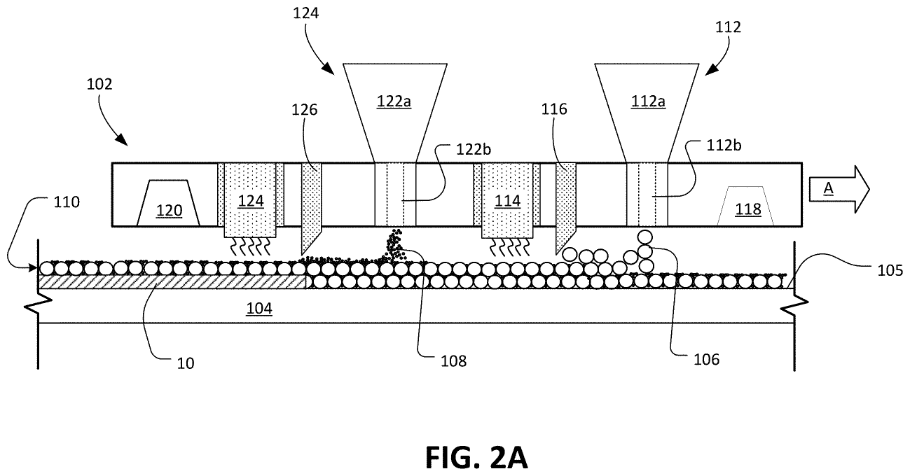

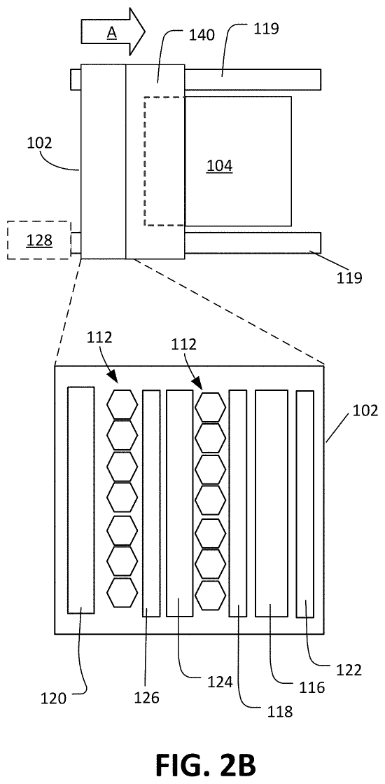

Referring to FIGS. 1 and 2B, the printhead 102 is configured to traverse the platform 104 (shown by arrow A). For example, the apparatus 100 can include a support, e.g., a linear rail or pair of linear rails 119, along which the printhead can be moved by a linear actuator and/or motor. This permits the printhead 102 to move across the platform 104 along a first horizontal axis. In some implementations, the printhead 102 can also move along a second horizontal axis perpendicular to the first axis.

The printhead 102 can also be movable along a vertical axis. In particular, after each layer is fused, the printhead 102 can be lifted by an amount equal to the thickness of the deposited layer 110 of powder. This can maintain a constant height difference between the dispenser on the printhead and the top of the powder on the platform 104. A drive mechanism, e.g., a piston or linear actuator, can be connected to the printhead or support holding the printhead to control the height of the printhead. Alternatively, the printhead 102 can be held in a fixed vertical position, and the platform 104 can be lowered after each layer is deposited.

Referring to FIGS. 2A and 2B, the printhead 102 includes at least a first dispenser 112 to selectively dispense a layer 110 of a powder 106 on the build platform 104, e.g., directly on the build platform 104 or on a previously deposited layer. In the implementation illustrated in FIG. 2A, the first dispenser 112 includes a hopper 112a to receive the powder 106. The powder 106 can travel through a channel 112b having a controllable aperture, e.g., a valve, that controls whether the powder is dispensed onto the platform 104. In some implementations, the first dispenser 112 includes a plurality of independently controllable apertures, so that the powder can be controllably delivered along a line perpendicular to the direction of travel A.

Optionally, the printhead 102 can include a heater 114 to raise the temperature of the deposited powder. The heater 114 can heat the deposited powder to a temperature that is below its sintering or melting temperature. The heater 114 can be, for example, a heat lamp array. The heater 114 can be located, relative to the forward moving direction of the printhead 102, behind the first dispenser 112. As the printhead 102 moves in the forward direction, the heater 114 moves across the area where the first dispenser 112 was previously located.

Optionally, the printhead 102 can also include a first spreader 116, e.g., a roller or blade, that cooperates with first the dispensing system 112 to compact and spread powder dispensed by the first dispenser 112. The first spreader 116 can provide the layer with a substantially uniform thickness. In some cases, the first spreader 116 can press on the layer of powder to compact the powder.

The printhead 102 can also optionally include a first sensing system 118 and/or a second sensing system 120 to detect properties of the layer before and/or after powder has been dispensed by the dispensing system 116.

In some implementations, the printhead 102 includes a second dispenser 122 to dispense a second powder 108. The second dispenser 122, if present, can be constructed similarly with a hopper 122a and channel 122b. A second spreader 126 can operate with the second dispenser 122 to spread and compact the second powder 108. A second heater 124 can be located, relative to the forward moving direction of the printhead 102, behind the second dispenser 122.

The first powder particles 106 can have a larger mean diameter than the second particle particles 108, e.g., by a factor of two or more. When the second powder particles 108 are dispensed on a layer of the first powder particles 106, the second powder particles 108 infiltrate the layer of first powder particles 106 to fill voids between the first powder particles 106. The second powder particles 108, being smaller than the first powder particles 106, can achieve a higher resolution, higher pre-sintering density, and/or a higher compaction rate.

Alternatively or in addition, if the apparatus 100 includes two types of powders, the first powder particles 106 can have a different sintering temperature than the second particle particles. For example, the first powder can have a lower sintering temperature than the second powder. In such implementations, the energy source 114 can be used to heat the entire layer of powder to a temperature such that the first particles fuse but the second powder does not fuse.

In implementations when multiples types of powders are used, the first and second dispensers 112, 122 can deliver the first and the second powder particles 106, 108 each into different selected areas, depending on the resolution requirement of the portion of the object to be formed.

Examples of metallic particles include metals, alloys and intermetallic alloys. Examples of materials for the metallic particles include titanium, stainless steel, nickel, cobalt, chromium, vanadium, and various alloys or intermetallic alloys of these metals. Examples of ceramic materials include metal oxide, such as ceria, alumina, silica, aluminum nitride, silicon nitride, silicon carbide, or a combination of these materials.

In implementations with two different types of powders, in some cases, the first and second powder particles 106, 108 can be formed of different materials, while, in other cases, the first and second powder particles 106, 108 have the same material composition. In an example in which the apparatus 100 is operated to form a metal object and dispenses two types of powder, the first and second powder particles 106, 108 can have compositions that combine to form a metal alloy or intermetallic material.

The processing conditions for additive manufacturing of metals and ceramics are significantly different than those for plastics. For example, in general, metals and ceramics require significantly higher processing temperatures. Thus 3D printing techniques for plastic may not be applicable to metal or ceramic processing and equipment may not be equivalent. However, some techniques described here could be applicable to polymer powders, e.g. nylon, ABS, polyetheretherketone (PEEK), polyetherketoneketone (PEKK) and polystyrene.

Returning to FIG. 1, the apparatus 100 also includes powder fusing assembly 140 that can translate across the build platform 140. The powder fusing assembly 140 includes at least one energy delivery system 150 that can generate at least one light beam 152 that is directed toward the uppermost layer of powder on the platform 104 and that can be used at least for fusing of the layer of powder on the platform 104. The light beam 152 and/or another light beam can be used for pre-heating and/or heat-treating the layer of powder. The light beam 152 can be scanned across the layer of powder by, e.g., a polygon mirror scanner, and/or one or more mirror galvo scanners, and/or by motion of the assembly 140.

The powder fusing assembly 140 also includes an air knife 160 to generate a flow of gas (shown by arrow 166) across the layer of power. The air knife can include an outlet 162 and an inlet 204 to generate a laminar flow of gas 166. This gas flow can help reduce spatter caused by fusing of the powder by the light beam 152.

As noted above, the powder fusing assembly 140 can translate across the build platform 140. For example, the apparatus 100 can include a support, e.g., a linear rail or pair of linear rails 149, along which the powder fusing assembly 140 can be moved by a linear actuator and/or motor. In some implementations, the printhead 102 and the powder fusing assembly 140 are independently movable. In some implementations, the printhead 102 and the powder fusing assembly 140 are mounted on separate tracks, e.g., rails 119 and 149, respectively. In some implementations, the powder fusing assembly 140 can translate along the same direction (e.g., shown by arrow A) as the printhead 102. Alternatively, the powder fusing assembly 140 can translate along a horizontal direction perpendicular to direction travelled by the printhead.

In some implementations, the printhead 102 and powder fusing assembly 140 are supported by and movable on the same support, e.g., the linear rail or pair of linear rails 119. In some implementations, the printhead 102 and the powder fusing assembly are physically connected (see FIG. 2B) in a fixed position relative to each other. In this case, the printhead 102 and powder fusing assembly 140 move together, e.g., by the same actuator or motor.

In some implementations, the printhead 102 and the powder fusing assembly 140 are mechanically coupled to the same vertical actuator such that both are movable up or down together. This permits the dispenser(s) and any beam scanner(s) of the powder fusing assembly to maintain a constant distance from the uppermost layer of power on a layer-by-layer basis. Alternatively, the printhead 102 and the powder fusing assembly 140 can be vertically fixed, and the platform 104 van be vertical movable.

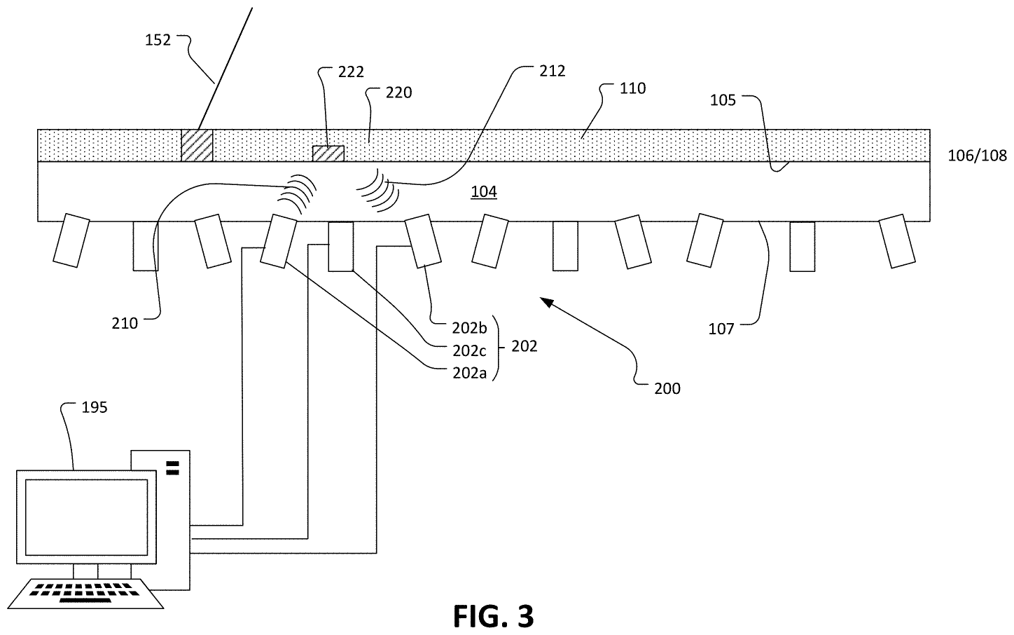

Referring to FIG. 3, the apparatus 100 also includes an in-situ ultrasonic monitoring system 200 that includes one or more ultrasound transducers 202 that are acoustically coupled to platform 104. The platform 104 is a solid body of a material with good transmission of ultrasonic energy, e.g., a solid metal body. The transducers 202 are configured to generate acoustic vibrations 210 at ultrasonic frequencies. For example, the transducers can be driven to generate vibrations at 0.25 to 20 MHz. In some implementations, frequency can be between 0.25 and 5 MHz, e.g., for monitoring of Ni alloys. In some implementations, the vibrations are in the megahertz range, e.g., 1 MHz to 20 MHz, e.g., 10 to 20 MHz. In general, the higher the frequency, the better the resolution of a defect.

These vibrations 210 are directed through the platform 104 toward the top surface 105. Some of the transmitted vibrations 210 can be reflected to form reflected vibrations 212, which can be sensed by the transducers 202. At least some of the transducers have overlapping regions from which they can sense vibrations. For example, vibrations 210 from transducer 202 can be reflected and sensed by transducer 202a and/or transducer 202b and/or transducer 202c.

In general, ultrasonic vibrations can be reflected where there is an interface between two regions having different acoustic transmission properties. Regions of a layer that are still in powder form will be more acoustically dampening than regions that are fused. Similarly, regions of a layer that are fused but have defects, e.g., inclusions or porosity, will have different acoustic properties than regions that are properly fused.

Signals from the sensors 202 can be used for ultrasonic monitoring of the part as it is being constructed. For example, a computer, e.g., controller 195, can receive signals from the transducers 202, and have a non-transitory computer readable medium configured with instructions to detect signal that do not meet predefined criteria or to perform ultrasonic imaging based on the signals. In particular, regions of a layer that are fused but have defects will appear in an ultrasonic image differently from regions that that are properly fused.

Without being limited to any particular theory, some of the transmitted vibrations 210 can be reflected from an interface between the top surface 105 of the platform 104 and regions 220 that are powder. On the other hand, where a solid part 222 has been formed, some of the vibrations 210 can be transmitted into the solid part 222, and reflected from either a layer of powder that extends over the part 222 or from an exposed top surface of the part 222. Still without being limited to any particular theory, because the vibrations 210, 212 travel farther through the solid part 222, there is a slight difference in transmission time and/or difference in frequency distribution. These differences can be sensed, and can be used to perform ultrasonic imaging of the part being fabricated based on the platform 104. Similarly, regions of a layer that are fused but have defects can have different transmission speeds or otherwise change the frequency distribution of the acoustic signal. Again, such differences will result in regions with defects appearing different than the properly fused regions during ultrasonic imaging. Ultrasound imaging can be performed by a variety of conventional algorithms used in medical ultrasound imaging techniques, albeit adjusted for the different acoustic transmission speeds in the part, e.g., a metal part, being fabricated.

The transducers 202 can be arranged to transmit vibrations into the platform 104 at an obtuse angle relative to the top surface 105. The transducers 202 can be arranged in groups of adjacent pairs (e.g., for 2D imaging) or tuples (e.g., for 3D imaging) of transducers. The transducers within an adjacent pair or tuple can be oriented inwardly, i.e., they are oriented to transmit toward a point located between the pair or tuple of transducers. For example, transducers 202a, 202b, 202c can be arranged to point at a point between the three transducers (transducer 202c would not be in the same vertical plane as transducers 202a and 202b). Alternatively, the transducers 202 can be arranged to transmit vibrations into the platform 104 at a normal angle relative to the top surface 105. For example, the transducers 202 can include normal incidence shear wave transducers be placed to obtain information on any defects that run parallel to the sound wave. The transducers pairs or tuples can be arranged to measure near-field and far field information. The tuples can be arranged around an acoustic axis (a perpendicular arrangement for complete back reflection from a volumetric defect for example).

Each transducer 202 can be a dual element transducer (the same element serves as a transmitter and a receiver) and contact transducer. Alternatively, separate elements could serve as the transmitter and a receiver.

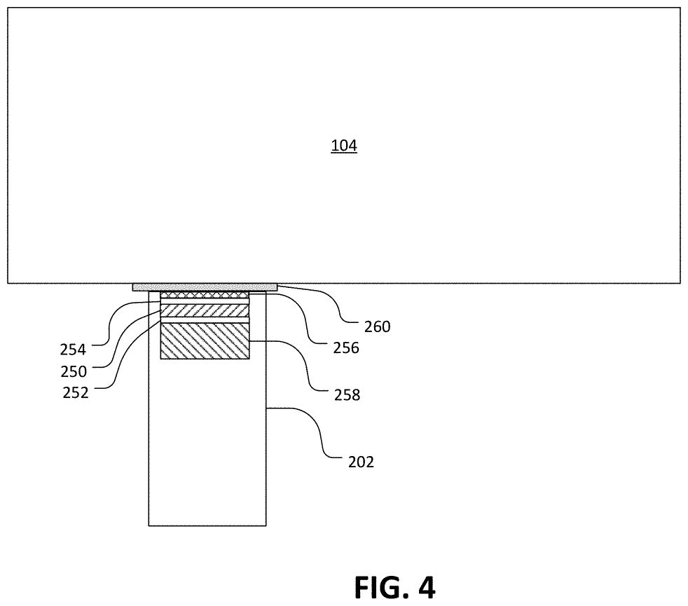

The transducer 202 can be a piezoelectric transducer. Referring to FIG. 4, a piezoelectric transducer can include a piezoelectric layer 250 sandwiched between a drive electrode 252 and a ground electrode 254. Optionally a wear plate 256 can cover the exterior of the “sandwich”; the wear plate 256 is the element that is placed into contact with the object or transmission medium. Optionally a backing material 258 can cover the interior of the “sandwich” to reduce vibrations from being transmitted toward the back of the transducer 202. An electric differential can be applied between the drive electrode 252 and ground electrode 254 to deform the piezoelectric layer 250 and generate ultrasonic vibrations that are transmitted through the wear plate 256 to the platform 104 and the part being fabricated. Similarly, ultrasonic vibrations returning to the transducer 202 will deform the piezoelectric layer 250 and generate an electric differential between the drive electrode 252 and ground electrode 254 that can be sensed and provides the signal that is provided to the computer 195.

Acoustic coupling between the platform 104 and the transducer can be established or enhanced by a coupling material 260, for example a gel which is a good transmitter of ultrasonic energy, e.g., glycerin.

Returning to FIG. 3, the transducers 202 can be fixed in position relative to the platform 104. For example, the transducers 202 can be mounted to the underside 107 of the platform 104. The transducers 202 can be placed to cover critical locations, e.g., regions where stitching is performed.

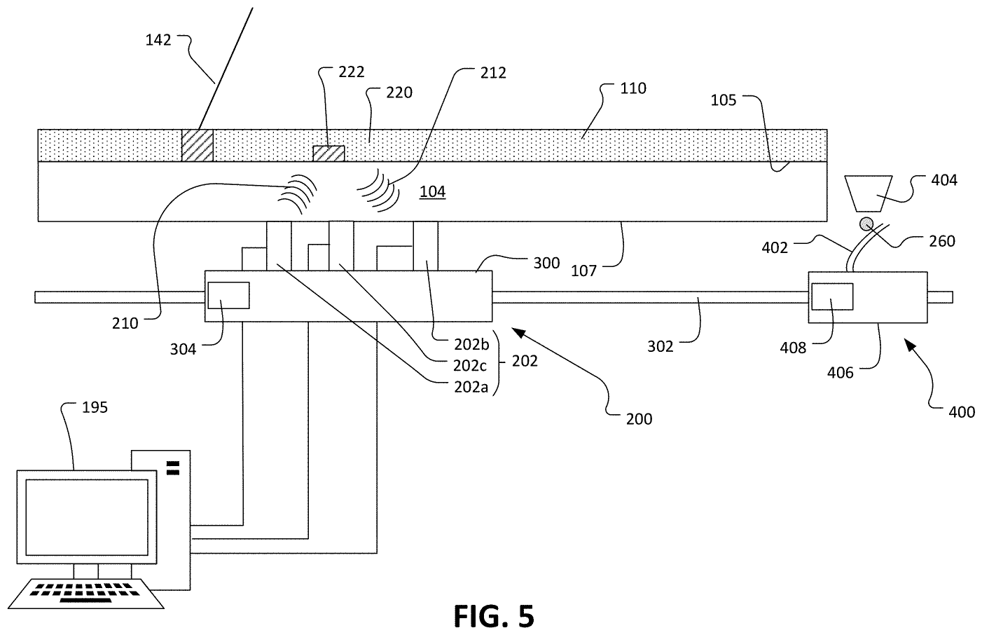

Referring to FIG. 5, in another implementation, an array of transducers 202 is movable across the platform 104. For example, the array of transducers 202 can be held by a support 300 that is linearly movable across the bottom of the platform 104. For example, the support 300 can be held on a rail 302 and movable along the rail 302 by an actuator 304.

As the array of transducers 202 traverses the platform 104, the transducer array can pause so that the transducers 202 can perform measurements at specified locations. The motion of the transducer array will be defined and controlled by the controller 195. The controller 195 can synchronize measurement locations with the part locations.

In some implementations, the apparatus 100 can include an applicator 400 configured to coat the surface of the platform 104, e.g., the bottom surface 107, that is contacted by the transducers 202 with the coupling material 260. For example, the applicator can include a brush 402 that can receive liquid coupling material 260 from a dispenser 404. The dispenser 404 can be stationary and can be positioned to the side of the platform 104. The brush 402 can be held by a support 406 that is that is linearly movable across the bottom of the platform 104. For example, the support 406 can be held on the same rail 302 as the support 300 or on a different rail, and be movable along the rail by an actuator 408. The dispenser 404 can deliver the coupling material 260 onto the brush, and then the brush can be moved across the platform 104 to brush the coupling material onto the bottom surface 107 of the platform 104/Turning to the operation of the in-situ ultrasonic monitoring system 200, the controller 195 can store data, e.g., as, indicating the desired shape of the part. In particular, the data can indicate, for each layer of powder, which portions are to be fused to form the part and which are not to be fused. The data can be a computer aided design (CAD)-compatible file that identifies the pattern in which the powder should be fused for each layer. For example, the data object could be a STL-formatted file, a 3D Manufacturing Format (3MF) file, or an Additive Manufacturing File Format (AMF) file. The controller 195 could receive the data object from a remote computer. A processor in the controller 195, e.g., as controlled by firmware or software, can interpret the data object received from the computer to generate the set of signals necessary to control the components of the apparatus 100 to deposit and/or fuse each layer in the desired pattern.

As noted above, the controller 195 can generate an ultrasonic image from the signals received from the ultrasonic monitoring system 200 (the image need not be displayed to a user on a monitor, but could simply be used internally by the apparatus 100). The controller 195 can also be configured to compare the ultrasonic image to the data indicating the desired shape of the part to detect any discrepancies from desired shape. This comparison can be performed on a layer by layer basis after each layer is deposited and fused. Ultrasonic monitoring typically would not occur during fusing of the powder, as the fusing induced by the light beam can generate significant acoustic noise.

In addition, the controller 195 can be configured to compare the ultrasonic image to the data indicating the desired shape of the part to detect defects. For example, regions with defects can appear as having different intensity in the image as compared to the properly fused regions. Assuming that the region, e.g., voxel, is indicated by the data to be fused, the controller 195 can compare the corresponding portion of the image to a threshold value. If the intensity value for the portion of the image fails to meet the threshold, e.g., has a value which indicates that the region is below a threshold density, the controller 195 can indicate this portion as having a defect.

The controller 195 can be configured to indicate that part failing to meet a quality standard if the number or density of detected defects exceeds a threshold. The part can then be scrapped or recycled. The controller 195 can be configured to halt the fabrication process if the number or density of detected defects exceed a threshold number or density. The partially completed part can then be scrapped or recycled. The controller 195 can be configured to adjust the fabrication process to correct detected defects. For example, the controller 195 can cause regions with defects to be re-fused by the light beam. The controller 195 can be configured to adjust the fabrication process to avoid generation of defects in the part or in a subsequent part. For example, if the controller 195 detects that regions of the layer are not being completely fused, the power of the light beam, e.g., laser beam, can be increased.

In some implementations, as part of a calibration process, a control part can be fabricated with defects along the thickness of the part. This control part can be analyzed using the in-situ ultrasound monitor 200. It will can be analyzed using other non-destructive methods after the build process. The measurement made after the build process can be used to calibrate mapping of the defect locations in the actual part during build process.

The apparatus 100 includes a controller 195 coupled to the various components of the apparatus, e.g., power sources for the light sources and heaters, actuators and/or motors to move the printhead 102 and powder fusing assembly 140, actuators and/or motors for the components, e.g., dispensers and beam scanners, within the printhead 102 and powder fusing assembly 140, etc., to cause the apparatus to perform the necessary operations to fabricate an object.

The controller 195 can include a computer aided design (CAD) system that receives and/or generates CAD data. The CAD data is indicative of the object to be formed, and, as described herein, can be used to determine properties of the structures formed during additive manufacturing processes. Based on the CAD data, the controller 195 can generate instructions usable by each of the systems operable with the controller 195, for example, to dispense the powder 106, to fuse the powder 106, to move various systems of the apparatus 100, and to sense properties of the systems, powder, and/or the object 10. In some implementations, the controller 195 can control the first and second dispensing systems 112, 122 to selectively deliver the first and the second powder particles 106, 108 to different regions.

The controller 195, for example, can transmit control signals to drive mechanisms that move various components of the apparatus. In some implementations, the drive mechanisms can cause translation and/or rotation of these different systems, including. Each of the drive mechanisms can include one or more actuators, linkages, and other mechanical or electromechanical parts to enable movement of the components of the apparatus.

### CONCLUSION

The controller and other computing devices part of systems described herein can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

A number of implementations have been described. Nevertheless, it will be understood that various modifications may be made. For example:
Other techniques can be used for dispensing the powder. For example, powder could be dispensed in a carrier fluid, e.g., a quickly evaporating liquid such as Isopropyl Alcohol (IPA), ethanol, or N-Methyl-2-pyrrolidone (NMP), and/or ejected from a piezoelectric printhead. Alternatively, the powder could be pushed by a blade from a powder reservoir adjacent the build platform.
For some powders, an electron beam could be used instead of a laser beam to fuse the powder. So the second energy delivery system could include an electron beam source and electron beam scanner rather than a light source and pair of galvo mirror scanners.
The various supports for the components can be implemented as a gantry supported on opposite ends (e.g., on both sides of the platform 104 as shown in FIG. 2B) or a cantilever assembly (e.g., supported on just one side of the platform 104).
Instead of or in addition to being attached to the bottom surface of the platen, the transducers could be attached to one or more side surfaces of the platen.

Accordingly, other implementations are within the scope of the claims

What is claimed is:

1. An additive manufacturing apparatus comprising:
a platform having a top surface to support a part being constructed;
a dispenser configured to deliver a plurality of successive layers of feed material onto the platform;
at least one energy source to selectively fuse feed material in a layer on the platform; and
an in-situ monitoring system comprising a plurality of ultrasonic sensors acoustically coupled to the platform and configured to transmit ultrasonic energy through the platform to the part being constructed on the platform and receive reflections of the ultrasonic energy through the platform from the part.

2. The apparatus of claim 1, comprising a computer having a non-transitory computer readable medium having instructions to receive signals from the in-situ monitoring system and perform ultrasonic imaging of the part being constructed based on the signals.

3. The apparatus of claim 2, wherein the computer-readable medium has instructions to compare an ultrasound image of the part to data indicating a desired shape of the part.

4. The apparatus of claim 1, wherein the plurality of ultrasonic sensors are acoustically coupled to a bottom surface of the platform.

5. The apparatus of claim 4, wherein the plurality of ultrasonic sensors contact the bottom surface of the platform.

6. The apparatus of claim 4, comprising a layer of coupling gel between the plurality of ultrasonic sensors and the bottom surface of the platform.

7. The apparatus of claim 1, wherein the plurality of ultrasonic sensors are fixed relative to the platform.

8. The apparatus of claim 1, wherein the plurality of ultrasonic sensors are movable parallel to the top surface of the platform.

9. The apparatus of claim 8, comprising a support that holds the plurality of ultrasonic sensors and a linear actuator to move the support relative to the platform.

10. The apparatus of claim 1, wherein at least some of the plurality of transducers are oriented to transmit acoustic waves into the platform at an oblique angle to the top surface of the platform.

11. The apparatus of claim 1, wherein the plurality of transducers comprise multiple groups of transducers, each transducer in a group of transducers being oriented to transmit acoustic waves toward a point between the transducers of the group.

12. The apparatus of claim 11, wherein the groups of transducers comprise pairs of transducers.

13. The apparatus of claim 11, wherein the groups of transducers comprise tuples of transducers.

14. The apparatus of claim 1, wherein at least some of the plurality of transducers are oriented to transmit acoustic waves into the platform at a normal angle to the top surface of the platform.

15. The apparatus of claim 1, wherein at least some of the plurality of transducers are positioned to receive the reflections of the ultrasonic energy from overlapping regions on the top surface of the platform.

16. A method of additive manufacturing of a part, the method comprising:
for each layer of a plurality of layers,
dispensing a layer of powder on a platform,
selectively fusing a portion of the layer of powder to form a fused portion of the layer,
transmitting ultrasonic energy through the platform toward the fused portion of the layer, and
generating signals by measuring reflections of the ultrasonic energy through the platform from the fused portion; and
detecting defects in the part based on the signal.

17. The method of claim 16, comprising performing ultrasonic imaging of the part being constructed based on the signals.

18. The method of claim 17, wherein comprising comparing an ultrasound image of the part to data indicating a desired shape of the part.

19. The method of claim 16, comprising halting fabrication of the part or indicating the part as defective if a number or density of defects exceeds a threshold.

20. The method of claim 16, comprising modifying an operating parameter of an additive manufacturing apparatus that performs the dispensing and fusing for a subsequent layer or a subsequent part to reduce defects.
